(19) United States
(12) Patent Application Publication
(10) Pub. No.: US 2005/0152363 A1
(43) Pub. Date: Jul. 14, 2005

(54) Disposable communications addresses

(75) Inventors: Dale Malik, Atlanta, GA (US); James Carlton Bedingfield SR., Lilburn, GA (US)

Correspondence Address: BAMBI FAIVRE WALTERS, PO BOX 5743, WILLIAMSBURG, VA, 23188, US

(73) Assignee: BellSouth Intellectual Property Corporation

(21) Appl. No.: 11/026,659

(22) Filed: Dec. 31, 2004

Related U.S. Application Data
(63) Continuation-in-part of application No. 09/741,346, filed on Dec. 21, 2000.

(51) Int. Cl. H04J 3/12; H04L 12/56; H04L 12/28; H04L 12/66

(52) U.S. Cl. 370/389; 370/352

(57) ABSTRACT

Disposable communications services are provided to enable a subscriber to maintain his or her privacy by communicating an incoming communication to a disposable communications address. According to an exemplary embodiment, a database associates the disposable communications address with a true communications address, a communications instruction, and/or subscriber information and a routing device processes the incoming communication to the disposable communications address. The disposable communications address may be a disposable telecommunications address and/or a disposable data communications address. The true communications address may be a true telecommunications address and/or a true data communications address.

### CROSS REFERENCE TO RELATED APPLICATION

This application is a continuation-in-part of commonly assigned U.S. patent application Ser. No. 09/741,346 entitled “Disposable Telephone Numbers,” (Attorney Docket BS00220) filed on Dec. 21, 2000, incorporated herein by this reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

The exemplary embodiments generally relate to telephony, and more particularly, to systems and methods for providing disposable communications addressing services.

Privacy is important to most people. Therefore, many individuals try to protect their privacy as much as possible. For example, many people do not want their telephone numbers be known to the public. To that end, they pay their telephone companies to avoid having their telephone numbers published in telephone directories. Unfortunately, having an unpublished telephone number cannot completely prevent unwanted incoming calls once a telephone number is voluntarily disclosed. The following examples illustrate the need for a disposable communications addressing service.

First, consider a situation in which a host accommodates an out-of-town guest in her home for several days. While staying with the host, the guest has a need to receive telephone calls. The host agrees that the guest may disclose the host's telephone number to the guest's calling party. The problem arises when the host continues to receive calls intended for the guest after the guest has left.

Second, consider a husband who advertises his family telephone number and/or an email address on the newspaper to sell a pick-up truck. The problem arises when he and his wife continue to receive unwanted telephone calls and/or emails about the pick-up truck after the vehicle is sold. A different problem might exist even if the vehicle has not been sold. For example, the wife might not want to entertain any inquiry about the pick-up truck when the husband is not available.

Third, consider a single woman who has developed a friendship with a man over the Internet in a chat room, decides to have a telephone conversation with the man. The woman gives her telephone number to the man, and he calls her. After the telephone conversation, the woman decides that she does not want to continue the relationship, and asks the man not to call her again. The problem arises when the man continues to call her despite her protests.

In each of the above examples, the problem could be solved by requesting a service provider such as, for example, a telephone company to assign a new, perhaps unpublished, telephone number to replace the disclosed telephone number. However, this solution is inconvenient, because the subscriber must then notify his or her friends and relatives about the new telephone number. Accordingly, there are needs for disposable communications addressing services that addresses the above problems and others.

### SUMMARY

According to exemplary embodiments, the needs described above and others are met by utilizing a disposable communications service for anonymity of a communications address to a called party. Some of the exemplary embodiments described herein include methods, systems, computer programs, and/or computer program products that provide the disposable communications services to a voice and/or data communications device, such as, for example, a Voice of Internet Protocol (VoIP) phone, a Plain Old Telephone System (POTS) phone, a computer, a cellular phone, an interactive pager, and/or to any communications device having a digital signal processor (DSP).

In an exemplary embodiment, a system for providing the disposable communications addressing service includes a database and a routing device. The database includes a true communications address identified by a subscriber that may be a true telecommunications address (e.g., a telephone number) and/or a true data communications address (e.g., an email address). Similarly, the disposable communications address may be a disposable telecommunications address and/or a disposable data communications address. The true communications address is associated with the disposable communications address and is also associated with a communications instruction. For example, the communications instruction may include instruction for establishing a communications connection of an incoming communication to the true telecommunications address, an instruction for not establishing the communications connection of the incoming communication to the true telecommunications address, an instruction for forwarding the incoming communication to a voice messaging system, and an instruction for presenting a message that the communications connection cannot be established with the disposable communications address. Further, the routing device is in communication with the database and is configured to receive an incoming communication addressed to the disposable communications address, to associate the disposable communications address with the true communications address, and to access the communications instruction associated with the true telecommunications address.

According to another exemplary embodiment, a method for providing the disposable communications address service includes creating the disposable communications address, assigning a true communications address with the disposable communications address, detecting and decoding an incoming communication to the disposable communications address; associating the true communications address and the communications instruction with the incoming communication to the disposable communications address, and processing the incoming communication in accordance with the communications instruction. For example, in processing the incoming communication in accordance with the communications instruction, a communications connection is established between the communications device of the incoming communication and with the true communications address. In further exemplary embodiments, the method includes communicating the incoming communication to an alternate communications address (e.g., a call forwarding address associated with the true telecommunications address). In still further embodiments, the method includes detecting and decoding a second incoming communication to the disposable communications address, associating the true communications address and the communications instruction with the second incoming communication with the disposable communications address, and processing the second incoming communication in accordance with the communications instruction. For example, a conference bridge may be established such that the communications connection includes the true communications address, the incoming communication, and the second incoming communication. And in even further exemplary embodiments, the communications instruction may identify a unique communications address of an incoming communication (e.g., a telephone call from a toll free number or an email address with a name string) and process that incoming communication to the true communications address differently than other incoming calls using the disposable communications service.

Some of the other embodiments include a computer program product that includes instructions for receiving a request from a requesting data communications address to establish a disposable communication address, communicating a response to the data communications address to provide a true communications address, associating the disposable communications address with the true communications address, and communicating the disposable communications address to the requesting data communications address (e.g., the subscriber) and/or a third party data communications address (e.g., a calling party). In further exemplary embodiments, the computer program product also includes instructions for detecting and decoding an incoming communication to the disposable communications address, associating the true communications address and a communications instruction with the incoming communication to the disposable communications address, and processing the incoming communication according to the communications instruction. Still in further exemplary embodiments, the computer program product may include instructions for communicating the disposable communications address to a third party data communications address. According to some of the embodiments, the true telecommunications address may include a telephone number provided by the subscriber, a telephone number associated with a communications device used to communicate a request for the disposable telephone number service, and/or a telephone number associated with a data communication address used to communicate the request for the disposable telephone number service. Similarly, other exemplary embodiments provide that the true data communications address includes an electronic communications address provided by the subscriber, an electronic communications address associated with a communications device used to communicate a request for the disposable communications address, and/or an electronic communications address associated with the requesting data communication address used to communicate the request for the disposable communications address.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The above and other embodiments, objects, uses, advantages, and novel features of this invention are more clearly understood by reference to the following description taken in connection with the accompanying figures, wherein:

FIG. 1 is a schematic diagram showing an exemplary system architect according to some of the embodiments of this invention.

FIG. 2 is a flowchart illustrating an exemplary disposable communications service using the exemplary system architect illustrated in FIG. 1.

FIG. 3 is a schematic diagram showing another exemplary system architect according to some of the embodiments of this invention.

FIG. 4 is a flowchart illustrating an exemplary disposable communications service for telecommunications addresses according to some of the embodiments of this invention.

FIG. 5 is a schematic diagram showing still another exemplary system architect according to some of the embodiments of this invention.

FIG. 6 is a flowchart illustrating an exemplary disposable communications service using the exemplary system architect illustrated in FIG. 5.

FIG. 7 is a schematic diagram showing yet another exemplary system architect according to some of the embodiments of this invention.

FIG. 8 is a flowchart illustrating an exemplary disposable communications service using the exemplary system architect illustrated in FIG. 7.

FIG. 9 is a schematic diagram showing still a further exemplary system architect according to some of the embodiments of this invention.

FIG. 10 is a flowchart illustrating an exemplary disposable communications service using the exemplary system architect illustrated in FIG. 9.

### DETAILED DESCRIPTION OF EXEMPLARY EMBODIMENTS

The exemplary embodiments now will be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, flowcharts, illustrations, and the like represent conceptual views or processes illustrating systems, methods and computer program products embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

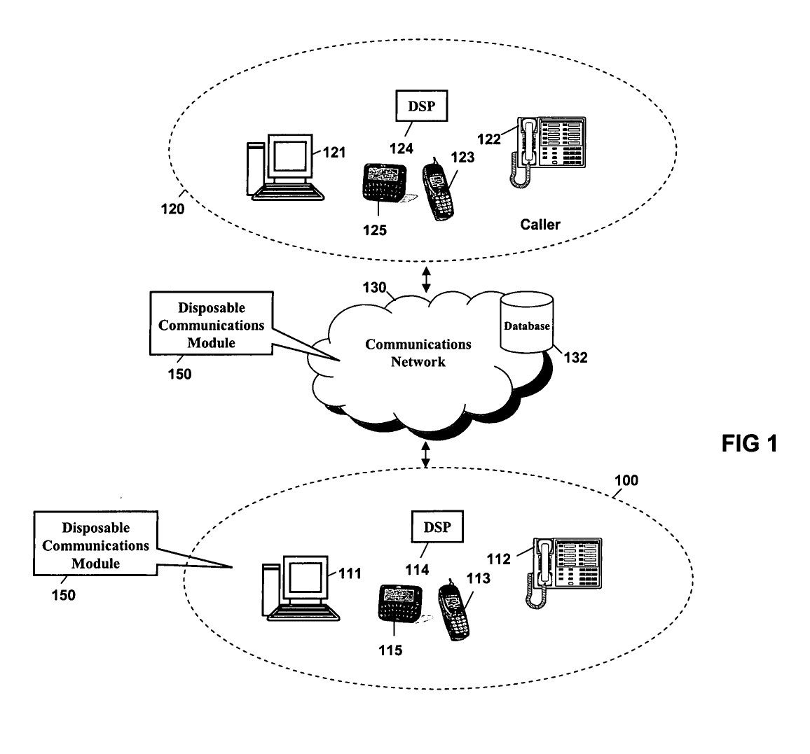

According to the exemplary embodiments, FIG. 1 is a schematic diagram showing an exemplary system architect that includes a subscriber's voice and/or data communications devices 100 interfacing with a disposable communications module computer program product 150 (hereinafter referred to as the “disposable communications module”), a communications network 100 having a database 132 and the disposable communications module 150, and a calling party's voice and/or data communications device 120. The subscriber's voice and/or data communications device 100 includes a computer 111, a Plain Old Telephone System (POTS) phone 112, a cellular phone 113, any communications device having a digital signal processor 114, and an interactive pager 115. Similarly, the calling party's voice and/or data communications device 120 includes a computer 121, a Plain Old Telephone System (POTS) phone 122, a cellular phone 123, any communications device having a digital signal processor 124, and an interactive pager 125. Other voice and/or data communications devices that may be used by the subscriber or the calling party may include a Voice Over Internet Protocol (VOIP) phone, a Personal Digital Assistant (PDA), an interactive television, a watch, a radio, vehicle electronics, a clock, a printer, a gateway, a console integrated into a piece of furniture and/or another apparatus and system. Further as used herein, the term subscriber further includes authorized users, such as, a person within the subscriber's household or a friend or a colleague of the subscriber, whether or not the user is the actual subscriber to the disposable communications service.

The communications network 130 may be a distributed computing network, such as the Internet (sometimes alternatively known as the “World Wide Web”), an intranet, a satellite network, a telecommunications network (e.g., Public Switched Telephone Network, Mobile Switching Telephone Office, and others), a local-area network (LAN), and/or a wide-area network (WAN). Still further, the communications network 130 may be a cable/television network operating in the radio-frequency domain and/or the Internet Protocol (IP) domain. The communications network 130 may include coaxial cables, copper wires, fiber optic lines, and/or hybrid-coaxial lines. The communications network 130 may even include wireless portions utilizing any portion of the electromagnetic spectrum and any signaling standard (such as the I.E.E.E. 802 family of standards).

The communications network 130 includes the database 132 that stores an association (e.g., a look up table) of one or more disposable communications addresses, one or more true communications addresses, and one or more communications instructions. The disposable communications address may include a true telecommunications address (e.g., a telephone number) and/or a true data communications address (e.g., an electronic communications address, such as, an email address, a web site, an Internet Protocol address and others). The true communications address may include a true telecommunications address and/or a true data communications address. Further, the communication instructions may include an instruction for establishing a communications connection of an incoming communication to the true telecommunications address, an instruction for not establishing the communications connection of the incoming communication to the true telecommunications address, an instruction for forwarding the incoming communication to a voice messaging system, and an instruction for presenting a message that the communications connection cannot be established with the disposable communications address. Further, the communication instruction may associate a disposable data communications address with a true telecommunications address, a disposable data communications address with a trued data communications address, a disposable telecommunications address with a true data communications address, and/or a disposable telecommunications address with a true telecommunications address. Thus, the communication instruction enables a wide range of communications flexibility for the subscriber (or user) to establish a preference for receiving incoming communications using the disposable communications addressing service. The communication instruction may be programmed or otherwise established via the disposable communications module 150 residing either in the subscriber's communications device or via an interface with the disposable communications module 150 residing within the communications network (e.g., talking with a service provider to establish the communications instruction, via a web interface, and so on).

In an exemplary embodiment, the communications network 130 is a telecommunications network that includes a dedicated switch that may be connected to the database 132. The database 132 includes a look up table that relates a disposable communications address with true communications address. When an incoming communication to a disposable communications address is detected and decoded by the dedicated switch of the communications network 130, a true communications address that is related to or associated with the disposable communications address can be retrieved from the database 132.

For example, assume that the subscriber provides or otherwise identifies a true communications address (123) 456-7890. The true communications address may be a communications address of a residence, a mobile and/or cellular device either owned or otherwise controlled by the subscriber, of a business (e.g., a work number), and/or of a public and/or municipal establishment (e.g., a phone located in an airport terminal). The subscriber may provide the true communications address to the service provider according to exemplary embodiments and obtain a disposable communications address. The disposable communications address may be, for example, (999) 332-2323. The service provider may then associate the disposable communications address with the true communications address in a look up table. The look up table may be stored in the database 132. The look up table may be, for example, as shown in Table 1 below.

TABLE 1
An Example of a Look Up Table

| Disposable telephone | | |
|---|---|---|
| number | Subscriber | True Telephone Number |
| 999-332-2323 | Subscriber 110 | 123-456-7890 |

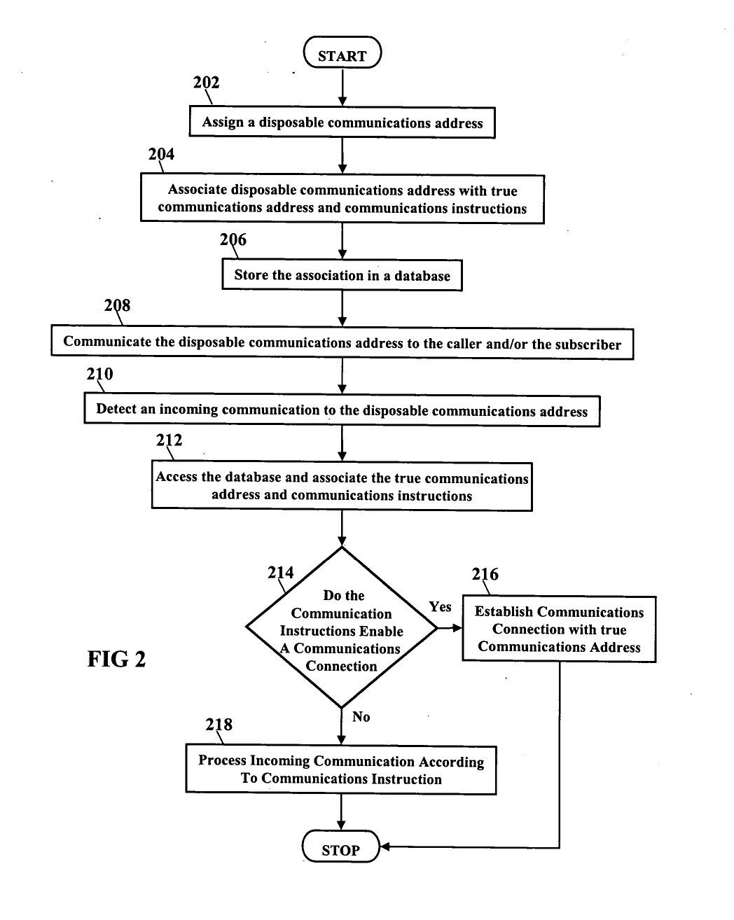

FIG. 2 is a flowchart showing an exemplary process of providing disposable communications services. In step 202, a subscriber (or other user) provides a true communications address of a voice and/or data communications device 100 that is assigned or otherwise provided with a disposable communications address. The true communications address may be a true telecommunications address and/or a true data communications address. Similarly, the disposable communications address may be a disposable telecommunications address or a disposable data communications address. In step 204, the disposable communications address can be related to or otherwise associated with the true communications address and with the communications instruction. For example, the 999-332-2323 disposable communications address can be associated with the 123-456-7890 true communications address as described above. And, in step 206, the association of the disposable communications address, the true communications address, and the communications address are stored in the database.

The communications instruction may include an instruction for establishing a communications connection of an incoming communication to the true telecommunications address (e.g., times of day, days of week for receiving communications from incoming communications addressed to the disposable number, preferences for routing the incoming communication to a particular true communications address—a cell phone, a residential phone, an email address, and so on), an instruction for not establishing the communications connection of the incoming communication to the true telecommunications address, an instruction for forwarding the incoming communication to a voice messaging system, and an instruction for presenting a message that the communications connection cannot be established with the disposable communications address. Further, the communications instruction may include a time period within which a communications connection is not established with the incoming communication to the disposable address to the true communications address (e.g., similar to call blocking features). And still further, each communication instruction may be established for a unique communications address of the incoming communication to the disposable communications address. For example, an incoming call from a calling party having an area code of “919” may be blocked, and, thus, the incoming call to the disposable communications address is not connected with the true communications address.

In step 208, the disposable communications address may be communicated to the calling party and/or to the subscriber. For example, if the subscriber (or user) uses computer 11 to access the disposable communications module 150 via a disposable communications service web site, the subscriber may input the request for the disposable communications address and include (1) the true communications address (e.g., a phone number and/or email address) and (2) a calling party's communications address (e.g., a calling party's phone number or a calling party's email address). The subscriber may be further prompted to provide billing information such as a credit card account or communications address for a billing statement along with authorization to charge for the disposable communications service. Thereafter, the disposable communications address may be immediately, near real-time, assigned and associated with the true communications address, a communications instruction, and/or a calling party's communications address. The disposable communications module 150 may communicate the disposable communications address to the subscriber via the web interface over computer 111 or by alternate means (e.g., a prerecorded voice and/or data message sent to the true communications address, such as a prerecorded voice message to cellular phone 113). And, the disposable communications module 150 may communicate the disposable communications address to calling party's communications device via a prerecorded voice and/or data message, such as a prerecorded voice message to calling party's cellular phone 123 or a text message to interactive pager 125).

In step 210, the calling party places an incoming communication addressed to the disposable communications address and the communications network 130 detects and decodes the incoming communication to determine or otherwise identify that the communications address is a disposable address. Thereafter, in step 212, the communications network 130 accesses database 132 to associate the disposable communications address with the true communications address(es) and the communications instruction(s).

In step 214, the communications network 130 or a processing device in communication with the communications network 130 processes the incoming communication in accordance with the communications instruction(s) For example, the communications instruction may include times of day for connecting the incoming communication and may also include an instruction for handling the incoming communication for different times as shown in Table 2 below.

TABLE 2
Communication Instruction

| | | Instructions | Instructions for |
|---|---|---|---|
| Disposable | | for Connecting | Not Connecting |
| Communications | True Communications | Incoming | Incoming |
| Address | Address | Communication | Communication |
| 919-XXX-XXX | 123-456-7890 | 9 AM-5 PM EST | Other times, route |
| | | | to voicemail and/or |
| | | | email and play |
| | | | announcement that |
| | | | incoming |
| | | | communications |
| | | | only accepted |
| | | | during 9 AM-5 PM EST |
| 504-123-4567 | (1) www.myname.com | Do NOT connect | Play announcement |
| | (2) 123-456-7890 | | that incoming |
| | | | communications not |
| | | | received from this |
| | | | calling party's |
| | | | communications |
| | | | address |

If the communications instruction enables connection of the incoming communication, then the method continues with step 216 and a communications connection is established with the true communications address. If, however, the communications instruction does not enable connection of the incoming communication, then the method continues with step 218 and the incoming communication is processed according to the communications instruction.

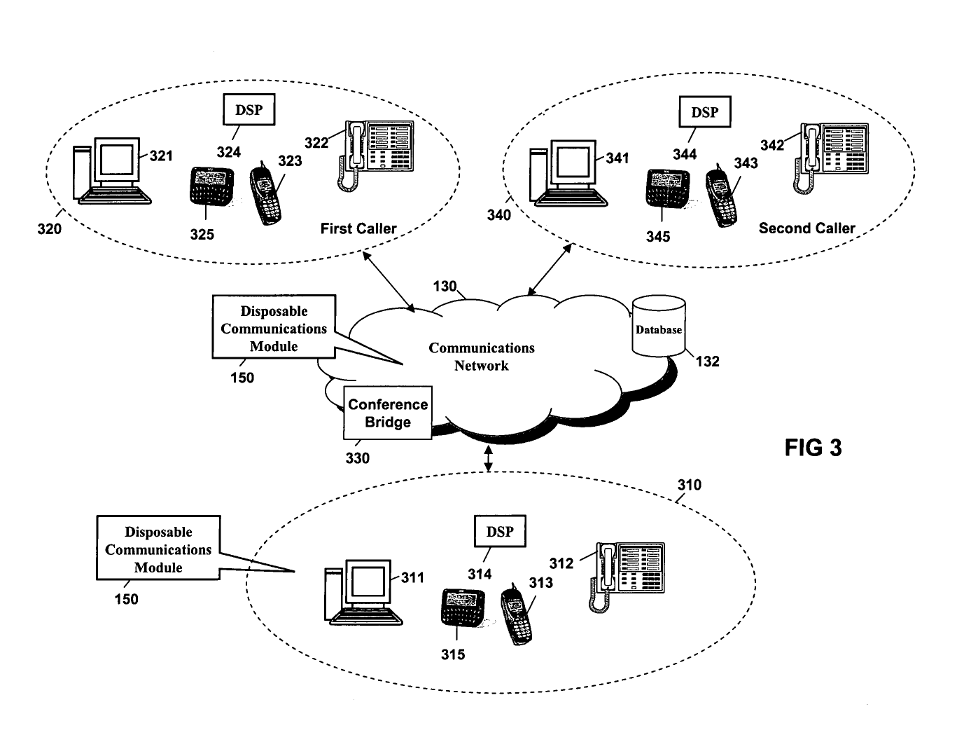

According to other exemplary embodiments, FIG. 3 is a schematic diagram showing an exemplary system architect that includes a subscriber's voice and/or data communications devices 310 interfacing with the disposable communications module, the communications network 100 having a database 132, the disposable communications module 150, and a conference bridge 330, and more than one calling party's voice and/or data communications devices 320 and 330. The subscriber's voice and/or data communications device 310 includes a computer 311, a POTS phone 312, a cellular phone 313, any communications device having a digital signal processor 314, and an interactive pager 315. The first calling party's voice and/or data communications device 320 includes a computer 321, a POTS phone 322, a cellular phone 323, any communications device having a digital signal processor 324, and an interactive pager 325. Similarly, the second calling party's voice and/or data communications device 340 includes a computer 341, a POTS phone 342, a cellular phone 343, any communications device having a digital signal processor 344, and an interactive pager 345. According to this exemplary embodiment, the disposable communications services includes a conference bridge 330 to receive, process, connect, and/or otherwise manage a plurality of incoming communications from a plurality of calling party's to the disposable communications address. For example, a meet-me conference bridge may used as conference bridge 330. An example of suitable meet-me conference bridge is that which is provided in the Nortel Networks DMS-100 switching system and populated in table “MMCONF” in the DMS system. Suitable hardware may include NT1X81AA and NT3X6AA of the DMS-100 system.

In an exemplary embodiment, the communications network 130 may include telephonic switching components and/or Advanced Intelligent Network (AIN) components that are commonly used in telecommunications central offices to route incoming calls. For example a service switching point (SSP) may be connected to the POTS phone 312. Similarly, another SSP may be connected to the first calling party's communications device 320 and still another SSP may be connected to the second calling party's communications device 340. As it would be apparent to one skilled in the art, this exemplary embodiment may be adapted for use in a variety of communications networks including a wireless telecommunications network, a data communications network, a satellite network, a cable/television network, and others.

The first calling party places an incoming communication addressed to the disposable communications address and the communications network 130 detects and decodes the incoming communication to determine or otherwise identify that the communications address is a disposable address. Thereafter, the communications network 130 accesses database 132 to associate the disposable communications address with the true communications address(es) and a communications instruction to use the conference bridge 330 to process the incoming communication from the first calling party's communications device 320. The second calling party also places an incoming communication addressed to the disposable communications address (this incoming communication may be placed simultaneously with the incoming communication of the first calling party or at an alternate time) and the communications network 130 detects and decodes the incoming communication to determine or otherwise identify that the communications address is a disposable address. Thereafter, the communications network 130 accesses database 132 to associate the disposable communications address with the true communications address(es) and a communications instruction to use the conference bridge 330 to process the incoming communication from the second calling party's communications device 340.

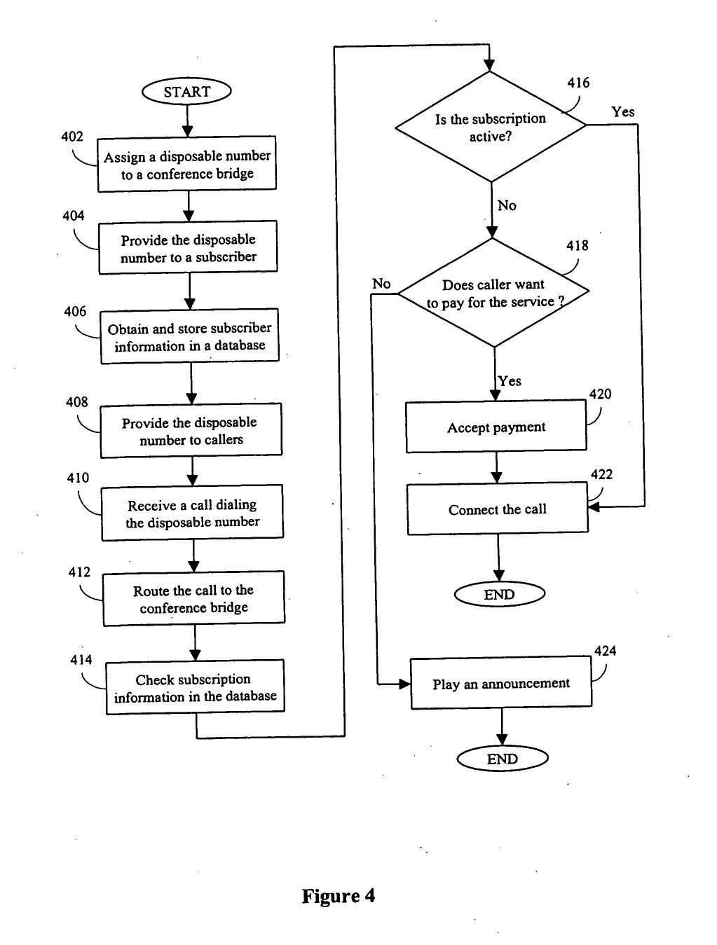

FIG. 4 is a flowchart showing an exemplary process of providing disposable communications services using a telecommunications network. In step 402, a service provider can assign a disposable communications address to the conference bridge 330. In step 404, the disposable communications address can be provided to subscriber and/or the calling party.

In step 406, subscriber information (i.e., a communications instruction) is obtained from subscriber. The subscriber information may include the time periods during which conference bridge 330 should be made available to process calls. For example, the subscriber information may specifically provide that conference bridge 310 must be available on a specific day during a specific time period. The subscriber information may further comprise information related to payment for the service. For example, the subscriber information may provide that each calling party of conference bridge 330 must pay for the service before the calling party will be allowed to use conference bridge 330.

In step 408, the subscriber provides the disposable communications address to one or more calling party's via the first calling party's communications device 320 and the second calling party's communications device 340. In step 410, when a person dials the disposable communications address, the call is received at a switch. Alternatively, if this embodiment was implemented with a data communications network, the incoming communication may utilize TCP/IP and/or other protocols to process the incoming communication. The person may be subscriber, first calling party 320, and/or second calling party 340. In the specific embodiment shown in FIG. 3, a call from subscriber, first calling party 320, and second calling party 340 would be received by telecommunications switching and/or AIN components that recognize the disposable communications address. Each of these SSPs or AIN components can then route the call to conference bridge 330 in step 412.

In step 414, the database 132 may be consulted. For example, conference bridge 330 may be preprogrammed to check the communications instruction related to the disposable communications address.

In step 416, the call is processed depending on whether the subscription is active. If the subscription is active, then the calling party dialing the disposable communications address may be connected to an available channel of conference bridge 330 in step 422. If the subscription is not active, the process may be routed to step 418. In step 418, the calling party may be asked if he or she would like to pay for the service. If the calling party wishes to continue by making a payment, the payment is received in step 420. The payment may be received, for example, by accepting the calling party's credit card number. In step 422, the calling party may be connected to an available channel of the conference bridge 330.

If the calling party does not want to pay for the service, then the method continues to step 424 in which an announcement may be played. The announcement may be, for example, “You have decided to abandon this call. Good Bye.”

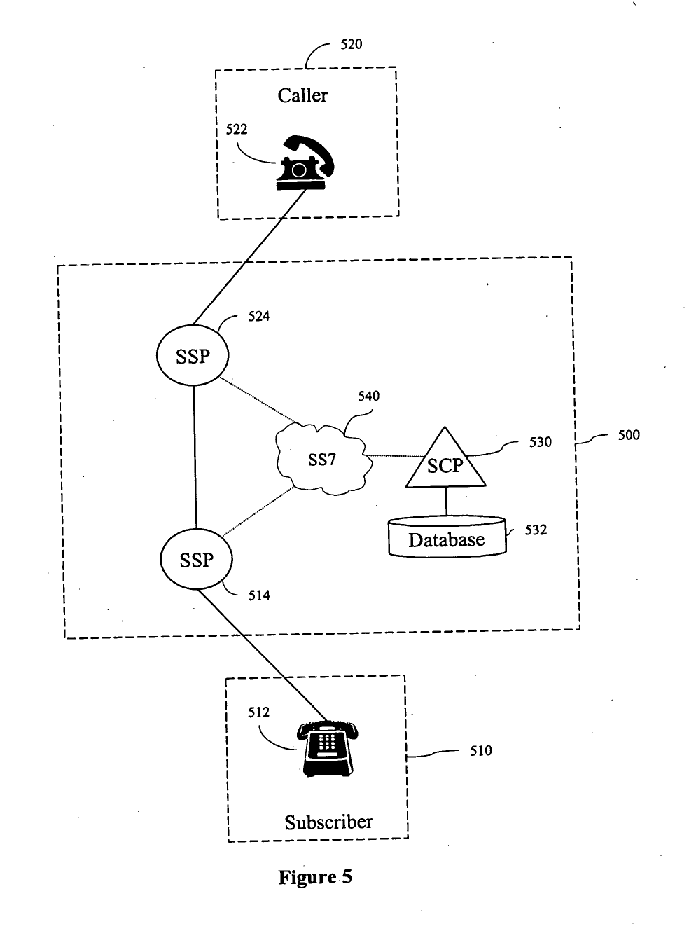

According to some of the embodiments, FIG. 5 is a schematic diagram of another exemplary system architect. Telephone network 500 can be an advanced intelligent network (AIN). Telephone network 500 may comprise, among other components, SSP 514, SSP 524, and SCP 530. SCP 530 may be a typical service control point in the AIN. Signaling between SCP 530 with SSP 514 and SSP 524 may be channeled through signaling system 540. Signaling system 540 may be any suitable signaling system. In the preferred embodiment, signaling system 540 may be Signaling System Seven, which is commonly known as SS7.

SCP 530 can access database 532. The database 532 comprises subscriber information (i.e., a communications instruction). For example, subscriber information related to or associated with subscriber 510 may be stored in database 532. The subscriber information may contain a relationship linking the true communications address of subscriber 510 and a disposable communications address of the exemplary embodiments. A query from a service switching point that carries the disposable communications address as the called number may be responded by SCP 530 with the true communications address as the called number in the response.

SSP 514 has communication with CPE 512 of subscriber 510. Similarly SSP 524 may have communication with CPE 522 of calling party 520. CPE 512 and CPE 522 may be telephone sets that can be used to make and receive telephone calls. As it is understood, the exemplary embodiments may be adapted for a wireless telephone network, a data communications network, a satellite network, a cable/television network, and other communications networks.

FIG. 4 is a flowchart showing an exemplary process of providing disposable communications services using a telecommunications network as described in FIG. 5. In step 602, telephone network 500 assigns a block of telephone numbers as disposable communications addresses. The disposable communications address preferably has a common prefix or NPA. For example, the NPA 999 may be used so that all disposable communications addresses may have the 999-NXX-XXXX 10-digit format.

In step 604, telephone network 500 creates database 532 that is dedicated for the disposable communications addresses. Database 532 may also be known as the disposable communications address database. Database 532 is preferably accessible by SCP 530.

In step 606, telephone network 500 may establish a subscription account with subscriber 510. As part of the subscription account, subscriber 510 may be provided with a disposable communications address. The account may be maintained by subscriber 510 based on any of several suitable payment schemes. For example, subscriber 510 may pay telephone network 500 a monthly fee for as many disposable communications addresses as subscriber 510 wishes to have in a month and associate each of those disposable communications address with many true communications addresses. Subscriber 510 may also pay telephone network 500 a fixed fee for each disposable communications address. In addition, subscriber 510 may pay telephone network 500 based on the number of incoming communications received using the disposable communications address service.

In step 608, telephone network 500 updates the database 532. For example, the disposable communications address assigned to subscriber 510 may be related to the true communications address of subscriber 510 in a look up table. The look up table may be stored in database 532. An example of a look up table may be similar to Table 1 described above.

In step 610, when calling party 520 dials the disposable communications address, SSP 524 recognizes that the dialed number is a disposable communications address. SSP 524 then launches a query to SCP 530. The query is preferably a TCAP message. The query may comprise, among other information, a called number field that contains the disposable communications address as the called number.

In step 614, SCP 530 uses the called number in the query to look up the true communications address in database 532. In step 616, SCP 530 further determines whether subscriber 510 has specific subscriber information in database 532.

In step 618, if the subscriber information in database 532 indicates that subscriber 510 does not want to receive calls at that time, the process goes to step 620. In step 620, an announcement may be played for calling party 520. The message may be, for example, “The subscriber of the disposable communications address you dialed does not receive calls at this time.”

If in step 618 it was determined that the subscriber information in database 532 indicates that subscriber 510 wishes to receive calls at the time calling party 520 dials the disposable communications address, the process goes to step 622. In step 622, SCP 530 substitutes the true communications address of subscriber 510 in the called number field for the disposable communications address.

In step 624, SCP 530 returns a response to SSP 524. The response is preferably a TCAP message. The response comprises the true communications address of subscriber 510 in the called number field.

In step 626, SSP 524 routes the call to the true communications address. In this example, a call is established between calling party 520 and subscriber 510 via SSP 524 and SSP 514. As a result, subscriber 510 can receive a call from calling party 520 without calling party 520 ever knowing the true communications address of subscriber 510. In a preferred embodiment, subscriber 510 may be alerted of an incoming call that uses the disposable communications address by a distinctive ringing on CPE 512.

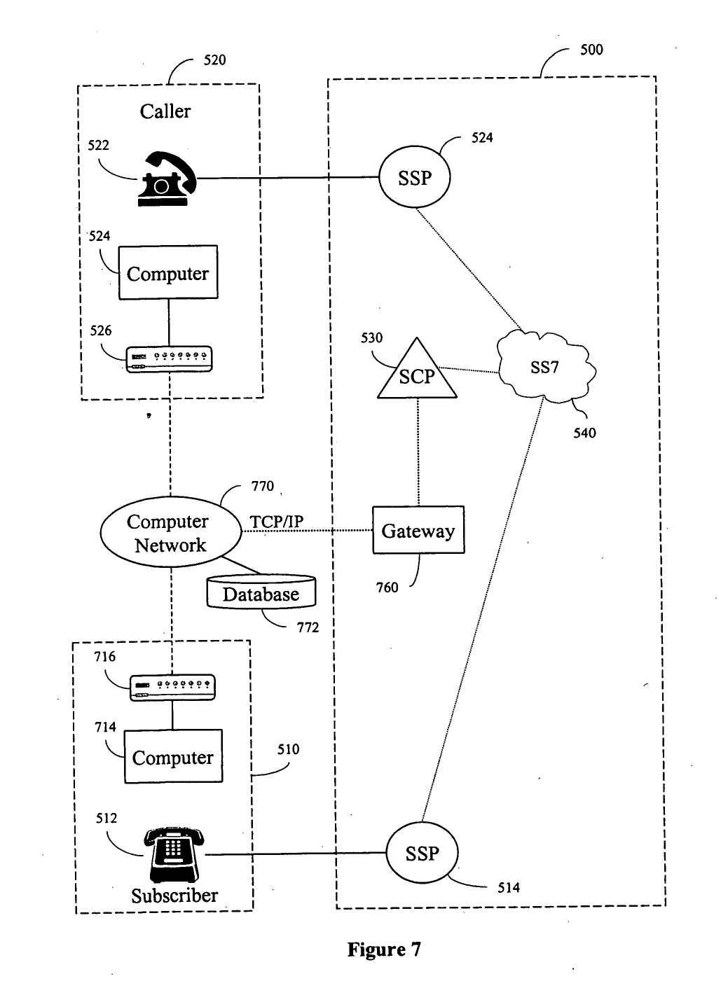

According to some of the embodiments, FIG. 7 is another schematic diagram of a further exemplary system architect. In this embodiment, telephone network 500 further comprises gateway 760 in addition to SSP 514, SSP 524, SCP 530, and signaling system 540. Gateway 760 enables SCP 530 to interact with non-AIN systems. For example, gateway 760 can enable SCP 530 to interact with computer network 770. In the preferred embodiment, computer network 770 is the Internet. Through gateway 760, SCP 530 and computer network 770 may communicate or interact with each other using known protocols. One example of suitable protocols is the transmission control protocol/Internet protocol that is more commonly known as TCP/IP.

In addition to CPE 512, subscriber 510 can have computer 714 and modem 716. Using computer 714 and modem 716, subscriber 510 can access computer network 770. Through computer network 770, subscriber 510 can have access to database 772. In the preferred embodiment, subscriber 510 can edit his or her subscriber information that is contained in database 772. SCP 530 may access database 772 as well. For example, SCP 530 may access database 772 via gateway 760 and computer network 770,

Subscriber 510 can also communicate with calling party 520 over computer network 770. For example, calling party 520 can access computer network 770 using computer 524 and modem 526. One example of communication between a subscriber 510 and a calling party 520 over the computer network 770 may be through an Internet chat room. In addition to communication over computer network 770, calling party 520 may contact subscriber 510 using CPE 522 through telephone network 500 as shown in FIG. 7. Alternatively, the calling party 520 may contact subscriber 510 through an alternate communications network, such as a satellite network or a data network (e.g., via an email address, a web page, and/or another electronic communications address)

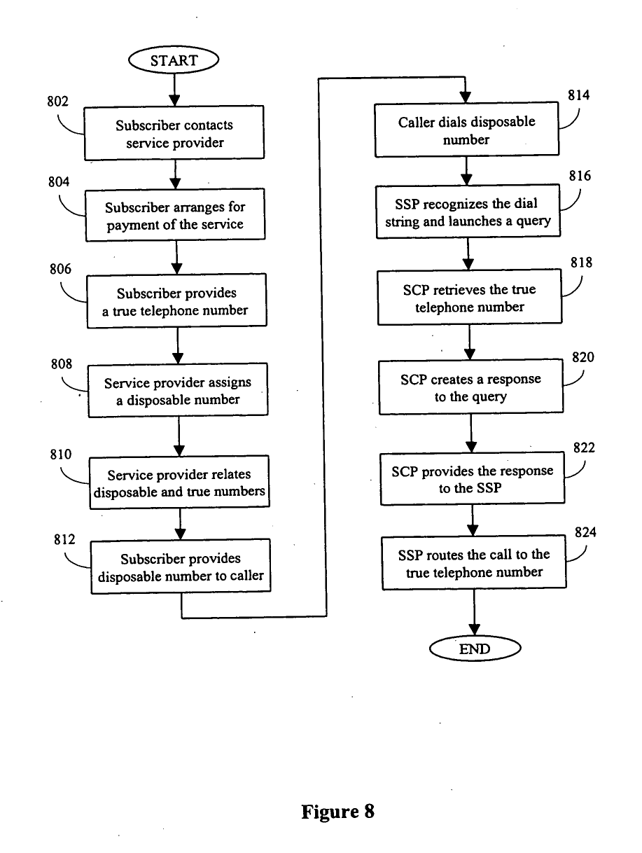

FIG. 8 is a flowchart showing an exemplary process of providing disposable communications services as described in FIG. 7. Considering a situation in which subscriber 510 and calling party 520 are two participants in an Internet chat room during a communication session. Subscriber 510 and calling party 520 decide to have a live telephone voice conversation, or, alternatively, a private electronic conversation.

In step 802, subscriber 510 may contact a service provider of the exemplary embodiments. The service provider may be any business entity. Preferably, the service provider is a telephony service provider. The contact may be made using a number of different methods. For example, subscriber 510 may call the business office of the service provider. Preferably, subscriber 510 may go to a website of the service provider by entering a uniform resource locator, e.g., www.chatonthephone.com, and be connected to the website over computer network 770. An alternative might be a conventional interactive, menu-driven system that is accessible via the telephone.

In step 804, subscriber 510 arranges for the payment of the disposable communications address service. Preferably, subscriber 510 can provide his or her credit number to the service provider. Other payment methods may include charging the fees for the disposable communications address to an account that can be authenticated or otherwise verified by the subscriber, such as part of subscriber 510's telephone bill. In step 806, subscriber 510 provides or otherwise selects his or her true communications address(es) (may be one or more true communications addresses) to which calls dialing an associated disposable telecommunications address will be routed, or alternatively, electronic communications associated with a disposable data communications addresses are routed (not shown). The true telecommunications address may be, for example, 123-391-3333.

In step 808, the service provider provides the disposable communications address to subscriber 510, and/or, alternatively may provide the disposable communications address to the calling party. The disposable communications address may have 10 digits in the format of NPA-NXX-XXXX. The disposable communications address may be, for example, 999-444-1212. Preferably, the three digits 999 are a dedicated NPA for disposable communications address services. In the preferred embodiment, the service provider advertises the service of the exemplary embodiments and the public is educated that all 999 telephone numbers are disposable communications addresses, just like all 800 telephone numbers are dedicated as toll free numbers.

In step 810, the service provider relates the disposable communications address to the true communications address of subscriber 510. The relationship between the disposable communications address and the true communications address may be established, for example, in a table or a database. For example, database 772 may be used to store the relationship between the disposable communications address and true communications address. In database 772, the true communications address 123-391-3333 is associated with the disposable communications address 999-444-1212.

Database 772 may be hereinafter referred to as the disposable number database. Database 772 may further comprise additional subscriber information. The additional subscriber information may comprise call routing instructions. For example, the disposable number database may comprise a specific time of day during which an announcement is played to the calling party when the call is received. The announcement may be, for example, “You have reached the disposable communications address service. The disposable communications address you have dialed is effective from January 1 to January 14. The subscriber of the disposable communications address service does not receive calls between 11 pm and 7 am.”

In step 812, subscriber 510 provides the disposable communications address to calling party 520. If subscriber 510 and calling party 520 were still online in the Internet chat room, subscriber 510 may provide the disposable communications address to calling party 520 during the Internet chat session.

In step 814, calling party 520 dials the disposable communications address 999-444-1212 using CPE 522. In step 816, SSP 524 recognizes the 999-444-1212 dial string as a disposable communications address. SSP 524 can therefore know that it has received a call intended for a subscriber of the service of the exemplary embodiments. SSP 524 can then launch a query to SCP 530. The query may contain the disposable communications address 999-444-1212 in the called number field of the query.

In step 818, when SCP 530 receives the query, SCP 530 uses the disposable communications address or the called number to retrieve the true communications address from database 772. Through gateway 760, SCP 530 may obtain the true communications address from database 772 over computer network 770 using TCP/IP.

In step 820, SCP 530 can generate or formulate a response to the query. The response may comprise the true communications address in the called number field, replacing the disposable communications address. In other words, SCP 530 can replace 999-444-1212 in the called number field with 123-391-3333. In step 822, SCP 530 provides the response to SSP 524. In step 824, SSP 524 routes the call from calling party 520 to subscriber 510 via SSP 514.

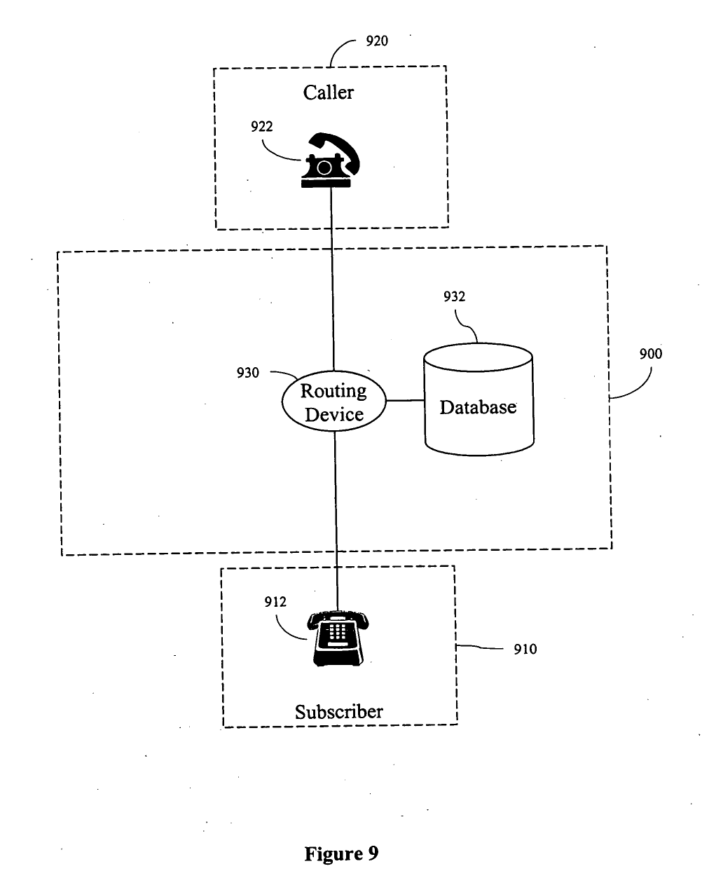

According to other exemplary embodiments, FIG. 9 is a schematic diagram of another exemplary system architect. The exemplary embodiments include routing device 930 and database 932. Routing device 930 may be any suitable devices, including those mentioned in the specific embodiments described above. For examples, dedicated switch 130, conference bridge 330, and SCP 530 may be used as routing device 930. In addition, telecommunications equipment suppliers such as Lucent Technologies and Nortel Networks may be provided with appropriate requirements to make new packetized switching devices suitable for use as routing device 930.

Database 932 can be any suitable memory devices that can associate disposable communications addresses with true communications addresses. Furthermore, database 932 may be used to store subscriber information as described above. Database 132, 332, 532, and 772 shown in FIGS. 1, 3, 5, and 7, respectively, are specific examples of database 932. Routing device 930 and database 932 are preferably owned and operated by service provider 900. As discussed above, service provider 900 may be a telephone company.

Subscriber 910 may have CPE 912. Subscriber 910 may use CPE 912 to obtain a disposable communications address from service provider 900. When calling party 920 dials the disposable communications address using CPE 922, the call is routed to routing device 930. Routing device 930 can consult database 932 for call routing instructions.

FIG. 9 is a flowchart showing an exemplary process of providing disposable communications services. In step 1002, service provider 900 creates a disposable communications address database. The database created may be database 932 that is connected to routing device 930, as shown in FIG. 9.

In step 1004, service provider 900 accepts an application from subscriber 910 who wishes to have a disposable communications address. In step 1006, service provider 900 stores subscriber information in database 932. The subscriber information includes the true communications address of subscriber 910. Preferably, the true communications address is associated with a disposable communications address that subscriber 910 can disclose to calling party 920. In addition, the subscriber information may include subscriber rules. An example of a subscriber rule is a specific time period within which subscriber 910 may not want to receive calls.

In step 1008, when calling party 920 dials the disposable communications address that has been assigned to subscriber 910, service provider 900 detects the call. Detection of the call may be done using any known methods. For example, the disposable communications address may have a dedicated NPA as part of the 10-digit telephone number. The call may be recognized by a switch that is connected to the telephone line of calling party 920.

In step 1010, the call is routed to routing device 930. In step 1012, database 932 is consulted. Using the disposable communications address, subscriber information and/or subscriber rules for subscriber 910 may be retrieved from database 932. In step 1014, it may be determined whether subscriber 910 wishes to accept the call. If the subscriber rules or subscriber information indicates that subscriber 910 would accept the call, the call is then processed in step 1016 in accordance with the subscriber information. Otherwise, an announcement may be played to calling party 920 in step 1018. The announcement may be, for example, “The subscriber of this disposable communications address does not accept calls at this time. Please try again later.”

According to these above exemplary embodiments and others, the true telecommunications address may include a telephone number provided by the subscriber, a telephone number associated with a communications device used to communicate a request for the disposable telephone number service, and a telephone number associated with a data communication address used to communicate the request for the disposable telephone number service. Further, the true data communications address may include an electronic communications address provided by the subscriber, an electronic communications address associated with a communications device used to communicate a request for the disposable communications address, and an electronic communications address associated with the requesting data communication address used to communicate the request for the disposable communications address.

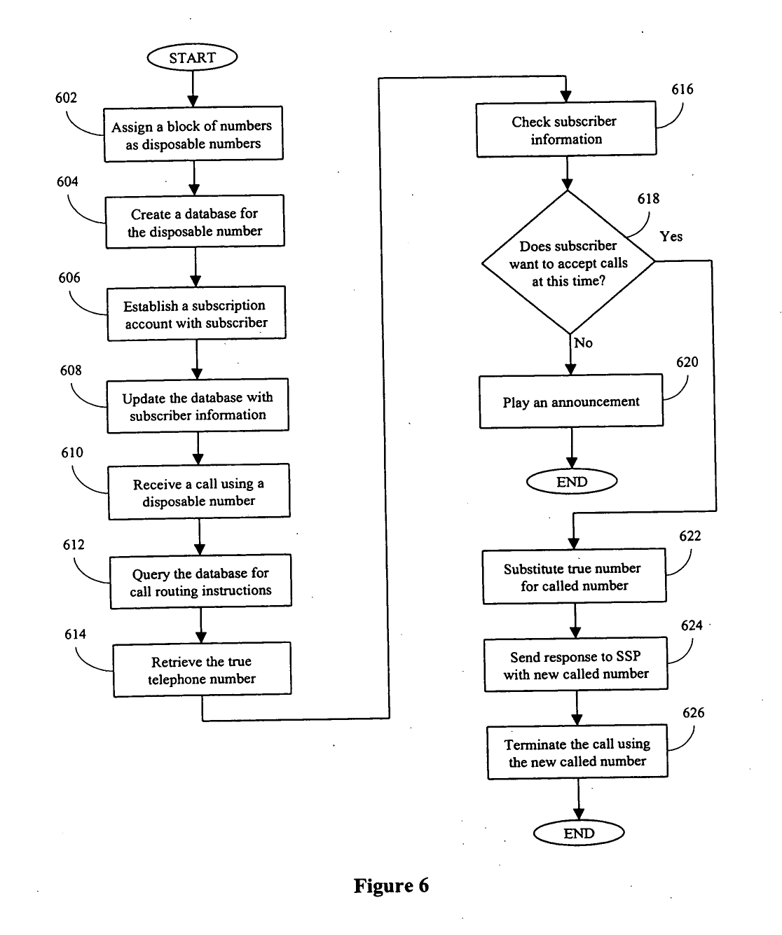

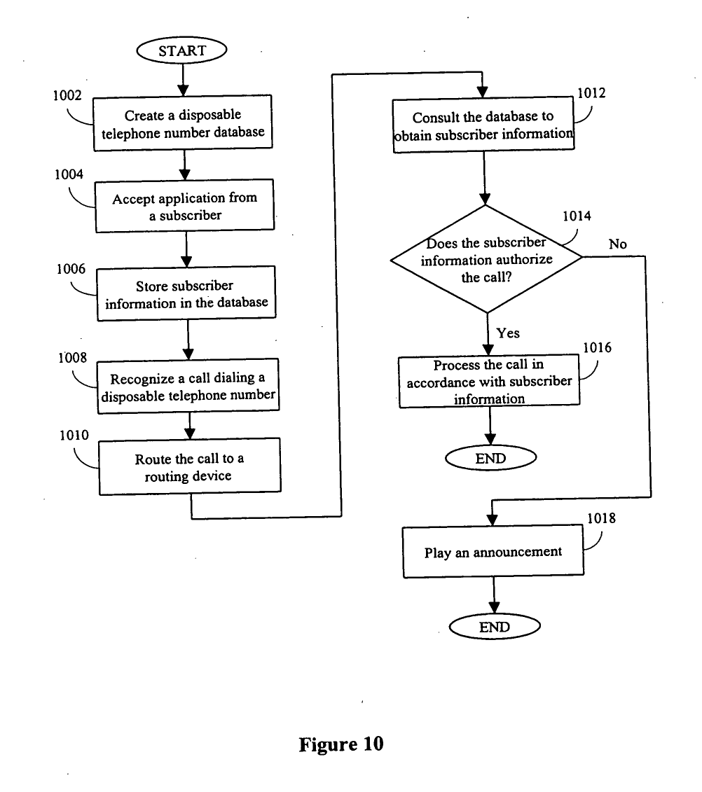

While several exemplary implementations of embodiments of this invention are described herein, various modifications and alternate embodiments will occur to those of ordinary skill in the art. Further the processes shown in FIGS. 2, 4, 6, 8, and 10 are shown in series; however, these processes may occur in different orders and/or at simultaneous times as one of ordinary skill in the art will understand. Accordingly, this invention is intended to include other series, other variations, other modifications, and alternate embodiments that adhere to the spirit and scope of this invention.

1. A system for providing a disposable communications addressing service comprising:
a database comprising a true communications address identified by a subscriber, the true communications address associated with a disposable communications address assigned to the subscriber, the true communications address comprising a true telecommunications address and a true data communications address and the disposable communications address comprising a disposable telecommunications address and a disposable data communications address, the true communications address associated with a communications instruction comprising an instruction for establishing a communications connection of an incoming communication to the true telecommunications address, an instruction for not establishing the communications connection of the incoming communication to the true telecommunications address, an instruction for forwarding the incoming communication to a voice messaging system, and an instruction for presenting a message that the communications connection cannot be established with the disposable communications address; and
a routing device in communication with the database, the routing device configured to receive an incoming communication addressed to the disposable communications address, to associate the disposable communications address with the true communications address, and to access the communications instruction associated with the true telecommunications address.

2. The system of claim 1, the routing device further processing the incoming communication according to the communications instruction.

3. The system of claim 1, wherein the communications instruction further comprises a time period within which the communications connection is not established with the true communications address.

4. The system of claim 1, wherein the communications instruction further comprises billing instructions associated with subscriber information for billing the disposable communications address to an account of the subscriber.

5. The system of claim 1, wherein the communications instruction comprises a near real-time activation feature to associate the true communications address with the disposable communications address when a request is received via the true data communications address.

6. The system of claim 1, wherein the routing device is a conference bridge, the conference bridge receiving more than one incoming communication to the disposable communications address, associating the communications instruction, and, if the communications instruction enables a communications connection, then enabling the communications connections with the more than one incoming communication.

7. The system of claim 1, wherein the communications instruction comprise unique communication instruction to associate with a communications address of the incoming communication, the communications address comprising an incoming telecommunications address and an incoming data communications address.

8. A method for providing a disposable communications address service, the method comprising:
creating at least one disposable communications address, the disposable communications address comprising a disposable telecommunications address and a disposable data communications address;
assigning a true communications address with the disposable communications address, the true communications address comprising a true telecommunications address and a true data communications address, the true communications address further associated with communications instruction comprising an instruction for establishing a communications connection of an incoming communication to the true telecommunications address, an instruction for not establishing the communications connection of the incoming communication to the true telecommunications address, an instruction for forwarding the incoming communication to a voice messaging system, and an instruction for presenting a message that the communications connection cannot be established with the disposable communications address;
detecting and decoding an incoming communication to the disposable communications address;
associating the true communications address and the communications instruction with the incoming communication to the disposable communications address; and
processing the incoming communication in accordance with the communications instruction.

9. The method of claim 8, wherein processing the incoming communication in accordance with the communications instruction comprises establishing the communications connection with the true communications address.

10. The method of claim 8, further comprising:
communicating the incoming communication to an alternate communications address, the alternate communications address provided by one of the communication instruction, an instruction by a service provider, and a forwarding instruction associated with the true communications address.

11. The method of claim 8, wherein the communications instruction further comprises a time period within which the communications connection is not established with the true communications address.

12. The method of claim 8, wherein the communications instruction comprises a near real-time activation feature to associate the true communications address with the disposable communications address when a request is received via the true data communications address.

13. The method of claim 8, further comprising:
detecting and decoding a second incoming communication to the disposable communications address;
associating the true communications address and the communications instruction with the second incoming communication to the disposable communications address; and
processing the second incoming communication in accordance with the communications instruction.

14. The method of claim 13, wherein processing the second incoming communication in accordance with the communications instruction comprises establishing a conference bridge such that the communications connection includes the true communications address, the incoming communication, and the second incoming communication.

15. The method of claim 8, wherein the communications instruction comprise unique communication instruction to associate with a communications address of the incoming communication, the communications address comprising an incoming telecommunications address and an incoming data communications address.

16. The method of claim 1, further comprising:
presenting a distinguishable alert of the incoming communication to the disposable communications address, the distinguishable alert comprising a presentation different than an alert for another incoming communication addressed to the true communications address.

17. A computer program product, comprising instructions for:
receiving a request from a requesting data communications address to establish a disposable communication address, the disposable communications address comprising a disposable telecommunications address and a disposable data communications address;
communicating a response to the data communications address to provide a true communications address, the true communications address comprising a true telecommunications address and a true data communications address;
associating the disposable communications address with the true communications address; and
communicating the disposable communications address to the requesting data communications address.

18. The computer program product of claim 17, further comprising instructions for:
detecting and decoding an incoming communication to the disposable communications address;
associating at least one of the true communications address and a communications instruction with the incoming communication to the disposable communications address, the true communications address further associated with communications instruction comprising an instruction for establishing a communications connection of an incoming communication to the true telecommunications address, an instruction for not establishing the communications connection of the incoming communication to the true telecommunications address, an instruction for forwarding the incoming communication to a voice messaging system, and an instruction for presenting a message that the communications connection cannot be established with the disposable communications address; and
processing the incoming communication according to the communications instruction.

19. The computer program product of claim 17, further comprising
communicating the disposable communications address to a third party data communications address.

20. The computer program product of claim 17, wherein the true telecommunications address comprises a telephone number provided by the subscriber, a telephone number associated with a communications device used to communicate a request for the disposable telephone number service, and a telephone number associated with a data communication address used to communicate the request for the disposable telephone number service, and wherein the true data communications address comprises an electronic communications address provided by the subscriber, an electronic communications address associated with a communications device used to communicate a request for the disposable communications address, and an electronic communications address associated with the requesting data communication address used to communicate the request for the disposable communications address.
